(19) United States
(12) Patent Application Publication
(10) Pub. No.: US 2026/0356766 A1
(43) Pub. Date: Nov. 12, 2026

(54) SPHERICAL BORON NITRIDE POWDER, RESIN FILLER, RESIN COMPOSITION, AND PRODUCTION METHOD FOR SPHERICAL BORON NITRIDE POWDER

(71) Applicant: Denka Company Limited, Tokyo (JP)

(72) Inventors: Eri KANEKO, Chuo Tokyo (JP); Kenji MIYATA, Chuo Tokyo (JP); Michiharu NAKASHIMA, Chuo Tokyo (JP)

(21) Appl. No.: 19/129,647

(22) PCT Filed: Nov. 13, 2023
(86) PCT No.: PCT/JP2023/040832

§ 371 Date: May 13, 2025

(30) Foreign Application Priority Data
Nov. 14, 2022 (JP) 2022-181481

(51) Int. Cl. C04B 35/583; C08K 3/38; C08K 7/18

(52) U.S. Cl. CPC C04B 35/583; C08K 7/18; C04B 2235/386; C04B 2235/528; C04B 2235/5409; C04B 2235/5436; C04B 2235/5445; C04B 2235/5472; C04B 2235/77; C08K 2003/385; C08K 2201/003; C08K 2201/006

(57) ABSTRACT

Provided are a spherical boron nitride powder that can achieve excellent fluidity when blended in a resin, a resin filler containing the spherical boron nitride powder, and a resin composition containing the spherical boron nitride powder. Provided is a spherical boron nitride powder having a tapped density of 0.30 g/cm³ or more. The spherical boron nitride powder preferably has an average particle diameter (D50) of 2.0 μm or less. In addition, the spherical boron nitride powder preferably has an average particle diameter (D90) of 10.0 μm or less and an average particle diameter (D10) of 0.5 μm or less.

### TECHNICAL FIELD

The present invention relates to a spherical boron nitride powder, a resin filler, a resin composition, and a production method for a spherical boron nitride powder.

### BACKGROUND

Hexagonal boron nitride (hereinafter referred to as “boron nitride”) has lubricity, high thermal conductivity, insulation properties, etc., and is widely used in solid lubricants, mold release agents such as molten gases and aluminum, fillers for heat dissipating materials, and the like.

As boron nitride particles that utilize lubricity and high thermal conductivity, which are the characteristics of boron nitride, Patent Document 1 describes scaly boron nitride particles having a small diameter/thickness ratio (aspect ratio), the boron nitride particles being submicron-sized, highly pure, and highly crystalline. Moreover, Patent Document 2 describes spherical boron nitride particles having a high degree of sphericity and a production method therefor.
Patent Document 1: WO 2015/122378 A
Patent Document 2: WO 2015/122379 A

### SUMMARY OF THE INVENTION

Generally, when resins are blended with inorganic fillers, the fluidity of resin compositions tends to decrease. Therefore, the objective of the present invention is to provide a spherical boron nitride powder that can achieve excellent fluidity when blended in a resin, a resin filler containing the spherical boron nitride powder, and a resin composition containing the spherical boron nitride powder.

As a result of diligent investigation, the present inventors discovered that a spherical boron nitride powder having a tapped density, measured under specific conditions, equal to or more than a certain value can solve the above-mentioned problem, thereby completing the present invention.

That is, the present invention has the following aspects.
[1] A spherical boron nitride powder having a tapped density of 0.30 g/cm³ or more.
[2] The spherical boron nitride powder according to [1], wherein the spherical boron nitride powder has an average particle diameter (D50) of 2.0 μm or less.
[3] The spherical boron nitride powder according to [1] or [2], wherein the spherical boron nitride powder has an average particle diameter (D90) of 10.0 μm or less and an average particle diameter (D10) of 0.5 μm or less.
[4] The spherical boron nitride powder according to any one of [1] to [3], wherein the spherical boron nitride powder has an average circularity of 0.70 or more.
[5] The spherical boron nitride powder according to any one of [1] to [4], wherein the spherical boron nitride powder has a specific surface area of 5 m²/g or more.
[6] The spherical boron nitride powder according to any one of [1] to [5], wherein a semi-quantitative value calculated from an O₁ₛ peak intensity measured by X-ray photoelectron spectroscopy is 0.6 or more.
[7] The spherical boron nitride powder according to any one of [1] to [6], wherein the spherical boron nitride powder is for filling a resin.
[8] A resin filler containing the spherical boron nitride powder according to any one of [1] to [7].
[9] A resin composition containing: the spherical boron nitride powder according to any one of [1] to [7]; and at least one resin selected from the group consisting of a thermoplastic resin and a thermosetting resin.

According to the present invention, it is possible to provide a spherical boron nitride powder that can achieve excellent fluidity when blended in a resin, a resin filler containing the spherical boron nitride powder, and a resin composition containing the spherical boron nitride powder.

### DESCRIPTION OF EMBODIMENTS

Hereinafter, one embodiment of the present invention will be explained in detail. The present invention is not limited to the embodiments below and can be implemented by adding modifications, as appropriate, so long as the effects of the present invention are not compromised. When a specific explanation regarding one embodiment also applies to another embodiment, that explanation may be omitted in the other embodiment. The expression “X-Y” indicating numerical ranges in the present disclosure means “X or more and Y or less”.

The configurations and combinations thereof in each embodiment are merely examples. Additions, omissions, replacements, and other changes of the configurations can be made as appropriate within the scope not deviating from the gist of the present disclosure. The present disclosure is not limited by the embodiments. The aspects disclosed in the present specification can be combined with any other feature disclosed in the present specification.

In the present disclosure, “spherical powder” means that when observed at a 10,000× magnification using a scanning electron microscope, a circular or rounded particle shape is observed. In addition, the term “powder” means an aggregate of particles.

### [Spherical Boron Nitride Powder]

The spherical boron nitride powder according to the present embodiment has a tapped density of 0.30 g/cm³ or more. The spherical boron nitride powder according to the present embodiment having a tapped density of 0.30 g/cm³ or more can provide a resin composition with excellent fluidity when blended in a resin. Note that the tapped density indicates a value calculated with the following method.

### (Method for Measuring Tapped Density)

First, a spherical boron nitride powder is dried at 120 °C for 5 hours. Thereafter, 5.00±0.02 g (M1) of the spherical boron nitride powder after drying is measured with a precision balance (a precision balance with a minimum weighing value of 0.001 g) and fed into a 50 mL graduated cylinder. Next, the graduated cylinder is lifted and dropped 500 times from a height of 3.5 cm. At this time, the graduated cylinder is dropped onto a rubber mat (with a thickness of 40 mm) so that the impact on the graduated cylinder is the same each time. After being dropped 500 times, the volume (V1) of the spherical boron nitride powder within the graduated cylinder is visually measured (to one decimal point). The tapped density of the spherical boron nitride powder is calculated from the following formula (1). The tapped density is calculated to two decimal points, rounding off the third decimal point. Moreover, the tapped density is calculated in “g/cm³”, with 1 mL in the graduated cylinder being 1 cm³. Note that the above-mentioned tapped density is measured under conditions of a temperature of 21-25 °C and a humidity of 50%±4%.

Tapped density (g/cm³): spherical boron nitride powder mass (M1)/V1 (1)

The spherical boron nitride powder according to the present embodiment has the characteristic that the tapped density measured with the above-mentioned method is 0.30 g/cm³ or more. A spherical boron nitride powder having such a high tapped density has not been conventionally known and is a novel powder.

A boron nitride powder in which the primary particles are spherical faces difficulty in synthesizing coarse particles and is easy to sinter in a bulky aggregated manner or in a state of being connected like beads during firing, which makes it difficult to obtain a powder having a high tapped density. The spherical boron nitride powder according to the present embodiment is a powder having a high tapped density, which has been conventionally considered to be difficult to achieve, made possible, for example, by producing the spherical boron nitride powder with the method described below. The spherical boron nitride powder according to the present embodiment, having such characteristics, can provide a resin composition having excellent fluidity. Note that the reason the spherical boron nitride powder according to the present embodiment can provide a resin composition having excellent fluidity is assumed to be that when the tapped density is 0.30 g/cm³ or more, it is possible to lower the viscosity of the resin composition because irregularly shaped particles or aggregates having large pores in the powder are reduced, the construction of particle network structures in the resin is difficult, and the like.

In one embodiment, the tapped density of the spherical boron nitride powder, measured under the above-mentioned conditions, may be 0.40 g/cm³ or more or 0.50 g/cm³ or more. Moreover, the upper limit of the tapped density is not particularly limited as long as it has the effects of the present invention, but from the perspective of making it easier to obtain a resin composition having excellent fluidity, the tapped density may be 1.00 g/cm³ or less, 0.80 g/cm³ or less, or 0.70 g/cm³ or less. That is, the spherical boron nitride powder may have a tapped density of 0.30-1.00 g/cm³, 0.30-0.80 g/cm³, 0.30-0.70 g/cm³, 0.40-1.00 g/cm³, 0.40-0.80 g/cm³, 0.40-0.70 g/cm³, 0.50-1.00 g/cm³, 0.50-0.80 g/cm³, or 0.50-0.70 g/cm³.

A spherical boron nitride powder having a tapped density of 0.30 g/cm³ or more is easily prepared by a production method that includes, for example, dispersing a raw material powder of a spherical boron nitride powder into a liquid containing cavitation bubbles, and thereafter recovering the raw material powder from the liquid and then drying the recovered raw material powder. Alternatively, the above spherical boron nitride powder is easily achieved when the Hausner ratio, represented by the ratio of the tapped density to bulk density, is in the range of 1.00-1.33.

In one embodiment, the spherical boron nitride powder has a Hausner ratio (tapped density (g/cm³)/bulk density (g/cm³)) of preferably 1.00-1.33, more preferably 1.00-1.25, even more preferably 1.00-1.19, and particularly preferably 1.00-1.11. Note that the bulk density of the spherical boron nitride powder can be measured with the following method.

### (Method for Measuring Bulk Density)

First, a spherical boron nitride powder is dried at 120 °C for 5 hours. Thereafter, 5.00±0.02 g (M2) of the spherical boron nitride powder after drying is measured with a precision balance (a precision balance with a minimum weighing value of 0.001 g) and fed into a 50 mL graduated cylinder. After feeding, the volume (V2) of the spherical boron nitride powder within the graduated cylinder is visually measured (to one decimal point). The bulk density of the spherical boron nitride powder is calculated from the following formula (2). The bulk density is calculated to two decimal points, rounding off the third decimal point. Moreover, the bulk density is calculated in “g/cm³”, with 1 mL in the graduated cylinder being 1 cm³. Note that the above-mentioned tapped density is measured under conditions of a temperature of 21-25 °C and a humidity of 50%±4%.

Bulk density (g/cm³): spherical boron nitride powder mass (M2)/V2 (2)

### <Average Particle Diameter>

The spherical boron nitride powder according to the present embodiment preferably has an average particle diameter (D50) of 2.0 μm or less. The average particle diameter (D50) of the spherical boron nitride powder refers to a volume-based cumulative diameter (D50) evaluated by using a laser diffraction/scattering method after performing a specific dispersion process, for example, a homogenization process. Moreover, “volume-based cumulative diameter (D50)” means a particle diameter in which the cumulative value corresponds to 50% in a volume-based cumulative particle size distribution measured by using a laser diffraction/scattering method. The cumulative particle size distribution is expressed as a distribution curve in which the horizontal axis represents the particle diameter (μm) and the vertical axis represents the cumulative value (%).

Generally, inorganic powders tend to have a larger tapped density as the average particle diameter (D50) (hereinafter, simply referred to as “D50”) increases. The spherical boron nitride powder according to the present embodiment has a tapped density of 0.30 g/cm³ or more, but the D50 is relatively small. In one embodiment, the spherical boron nitride powder has a D 50 of 1.5 μm or less, 1.0 μm or less, 0.9 μm or less, 0.8 μm or less, or 0.7 μm or less. Moreover, the lower limit of the D50 of the spherical boron nitride powder is not limited as long as it has the effects of the present invention, but may be, for example, 0.01 μm or more, 0.05 μm or more, 0.1 μm or more, 0.2 μm or more, 0.3 μm or more, or 0.4 μm or more. For the D50 of the spherical boron nitride powder according to the present embodiment, any combination of the above-mentioned preferred upper and lower limits may be adopted so long as the tapped density is within the range of 0.30 g/cm³ or more.

Even if the D50 is relatively small as described above, the spherical boron nitride powder according to the present embodiment tends to have a tapped density of 0.30 g/cm³ or more, and is likely to become a powder with excellent fluidity.

In one embodiment, the spherical boron nitride powder preferably has an average particle diameter (D90) of 10.0 μm or less and an average particle diameter (D10) of 0.5 μm or less. The average particle diameter (D90) refers to a volume-based cumulative diameter (D90) evaluated by using a laser diffraction/scattering method after performing a specific dispersion process, for example, a homogenization process Moreover, “volume-based cumulative diameter (D90)” means a particle diameter in which the cumulative value corresponds to 90% in a volume-based cumulative particle size distribution measured by using a laser diffraction/scattering method. The cumulative particle size distribution is expressed as a distribution curve in which the horizontal axis represents the particle diameter (μm) and the vertical axis represents the cumulative value (%). The average particle diameter (D10) can also be measured with the same method as the average particle diameter (D90). The average particle diameter (D10) means a particle diameter (volume-based cumulative diameter (D10)) in which the cumulative value corresponds to 10% in a volume-based cumulative particle size distribution measured by using a laser diffraction/scattering method.

If the average particle diameter (D90) and average particle diameter (D10) of the spherical boron nitride powder are within the above-mentioned ranges, the spherical boron nitride powder is more likely to have excellent fluidity.

In one embodiment, the spherical boron nitride powder having a D50 of 0.1-0.4 μm may have an average particle diameter (D90) of 0.10-0.8 μm, 0.25-1.0 μm, or 0.6-2.5 μm.

Moreover, the spherical boron nitride powder having a D50 of 0.1-0.4 μm may have an average particle diameter (D10) of 0.06-0.3 μm, 0.05-0.2 μm, or 0.02-0.1 μm.

In one embodiment, the spherical boron nitride powder having a D50 of more than 0.4 μm and 1.0 μm or less may have an average particle diameter (D90) of 0.7-1.8 μm, 1.6-2.5 μm, or 2.4-6.0 μm.

Moreover, the spherical boron nitride powder having a D50 of more than 0.4 μm and 1.0 μm or less may have an average particle diameter (D10) of 0.2-0.7 μm, 0.2-0.5 μm, or 0.05-0.2 μm.

In one embodiment, the spherical boron nitride powder having a D50 of more than 1.0 μm and 2.0 μm or less may have an average particle diameter (D90) of 1.8-3.6 μm, 2.5-5.0 μm, or 6.0-12 μm.

Moreover, the spherical boron nitride powder having a D50 of more than 1.0 μm and 2.0 μm or less may have an average particle diameter (D10) of 0.6-1.4 μm, 0.5-1.0 μm, or 0.1-0.4 μm.

### <Average Circularity>

In one embodiment, the spherical boron nitride powder may have an average circularity of 0.70 or more, 0.75 or more, 0.80 or more, or 0.87 or more. If the spherical boron nitride powder has an average circularity of 0.70 or more, the spherical boron nitride powder is more likely to have excellent fluidity. Note that “average circularity” can be calculated with the following method.

### (Method for Measuring Average Circularity)

Image analysis software (for example, product name: “MacView” manufactured by Mountech Co., Ltd.) is used to perform image analysis on an image of a powder (magnification: 10,000×, image resolution: 1280×1024 pixels), captured by using a scanning electron microscope (SEM), to calculate the projected area(S) and perimeter (L) of one particle. The circularity is calculated by substituting the projected area(S) and perimeter (L) into the following formula (3). The average value of the circularities determined for 200 arbitrary particles is defined as the average circularity.

Circularity=4πS/L² (3)

### <Specific Surface Area>

The tapped density of the inorganic powder usually tends to be larger when the specific surface area is smaller. When the spherical boron nitride powder according to the present embodiment is, for example, produced by the production method described below, even the spherical boron nitride powder having a large specific surface area can have an increased tapped density. Here, a large specific surface area refers to a BET specific surface area of 5 m²/g or more measured under the following condition. In one embodiment, the spherical boron nitride powder may have a specific surface area of 5 m²/g or more, 6 m²/g or more, 7 m²/g or more, 8 m²/g or more, 9 m²/g or more, or 10 m²/g or more. The upper limit of the specific surface area is not limited as long as it has the effects of the present invention, but may be 35 m²/g or less, 32 m²/g or less, 30 m²/g or less, 27 m²/g or less, 25 m²/g or less, 22 m²/g or less, 20 m²/g or less, 17 m²/g or less, or 15 m²/g or less. For the specific surface area of the spherical boron nitride powder according to the present embodiment, any combination of the above-mentioned preferred upper and lower limits may be adopted so long as the tapped density is within the range of 0.30 g/cm³ or more.

### <Method for Measuring Specific Surface Area>

The BET specific surface area of the spherical boron nitride powder is measured with the BET multiple-point method using nitrogen gas, in accordance with JIS Z 8830:2013.

In one embodiment, a semi-quantitative value calculated from the O₁ₛ peak intensity of the spherical boron nitride powder measured by X-ray photoelectron spectroscopy is preferably 0.6 or more, more preferably 0.65 or more, and even more preferably 0.7 or more. In the present disclosure, “semi-quantitative value calculated from an O₁ₛ peak intensity measured by X-ray photoelectron spectroscopy” refers to a semi-quantitative value obtained by measuring an spherical boron nitride powder using an X-ray photoelectron spectroscopy device (e.g., product name: K-Alpha type X-ray photoelectron spectrometer manufactured by Thermo Fisher Scientific Inc., AI X-ray source with monochromator; measurement region: 400×200 μm) to obtain a spectrum, removing the background of the spectrum with the Shirley method, and performing calculation from the O^{1s} peak intensity. More specifically, “O₁ₛ semi-quantitative value” can be the value of the O₁ₛ peak area in the inorganic powder, measured according to the manual of the X-ray photoelectron spectrometer. Herein, “Shirley method” refers to a method for determining a shape of a subtracted background with an assumption that there is no energy dependency with respect to background-causing inelastically scattered electrons, or that the number of electrons that scatter inelastically is proportional to a peak intensity.

As mentioned above, the spherical boron nitride powder according to the present embodiment can provide a resin composition having excellent fluidity. In one embodiment, a resin composition containing the spherical boron nitride powder according to the present embodiment measured under the following condition may have a viscosity (viscosity at the time of shear rate 0.1 (1/s)) of 100 Pa·s, or 50 Pas or less, or 30 Pa·s or less.

### (Method for Measuring Viscosity of Resin Composition)

An epoxy resin (e.g., product name: “YDF-8170C” manufactured by NIPPON STEEL Chemical & Material Co., Ltd.) has a dispersing agent (e.g., “DISPERBYK-111” manufactured by BYK Chemie Japan, 0.3 mass %), an SC agent (e.g., “3-Glycidyloxypropyltrimethoxysilane” manufactured by Tokyo Chemical Industry, Ltd., 1 mass %), and 15 mass % of the spherical boron nitride powder according to the present embodiment added thereto, and the obtained mixture is kneaded for 3 minutes at room temperature, a revolution speed of 2,000 rpm, and a rotation speed of 800 rpm using a hybrid mixer (e.g., product name: “Awatori Rentaro® AR-250” manufactured by Thinky Corporation). Thereafter, the mixture is kneaded twice using a three-roller miller (e.g., “BR-150VIII” manufactured by Aimex Co., Ltd., gap: 10 μm, finishing roll rotation speed: 60 rpm) to obtain a resin composition for evaluation. The viscosity of the obtained resin composition is measured at the time of shear rate 0.1 (1/s) when the shear rate was varied, at 25 °C, from 0.01 (1/s) to 100 (1/s) and then back from 100 (1/s) to 0.01 (1/s) to measure the viscosity using a rheometer (e.g., product name: “MCR92” manufactured by Anto Paar GmbH”).

### (Use)

The spherical boron nitride powder according to the present embodiment can provide a resin composition having excellent fluidity. Therefore, the spherical boron nitride powder can be preferably used as a resin filler.

### <Resin Filler>

The resin filler according to the present embodiment contains the above-mentioned spherical boron nitride powder. From the perspective of obtaining a resin composition having more excellent fluidity, the resin filler may be constituted only by the above-mentioned spherical boron nitride powder. Note that the resins in which the resin filler according to the present embodiment can be blended are not particularly limited, and the resin filler can be blended in conventionally known thermosetting resins and thermoplastic resins.

### [Production Method of Spherical Boron Nitride Powder]

The spherical boron nitride powder according to the present embodiment can be prepared by a production method, etc. including dispersing a raw material powder into a liquid containing cavitation bubbles (step (I)); and recovering the raw material powder from the liquid and then drying the recovered raw material powder (step (II)). Hereinafter, one aspect of the production method for the spherical boron nitride powder according to the present embodiment, including steps (I) and (II), will be described.

### <Step (I)>

The production method according to the present embodiment includes dispersing a raw material powder into a liquid containing cavitation bubbles (step (I)). Herein, “cavitation bubbles” means bubbles that are generated by liquid vaporization when a liquid reaches a low-pressure state.

Examples of methods for dispersing a raw material powder into liquid containing cavitation bubbles include a method for feeding a raw material powder into a liquid containing cavitation bubbles and then mechanically stirring, a method for utilizing cavitation bubbles to disperse a raw material powder into a liquid, and the like.

When a raw material powder is dispersed in a liquid containing cavitation bubbles, the bubbles generated by cavitation expand and contract due to the pressure difference, and this force breaks down the aggregated particles (including secondary particles) in the raw material powder to be broken down. As a result, the proportion of the primary particles in the raw material powder is likely to increase. Recovering and drying such raw material powder with the method described below makes it easier to obtain the spherical boron nitride powder according to the present embodiment having a tapped density of 0.30 g/cm³ or more. In the production method according to the present embodiment, step (I) preferably includes loosening aggregated particles in a raw material powder using cavitation bubbles (that is, breaking down the aggregated particles). The above-mentioned loosening step includes breaking down the aggregated particles to their primary particles.

Note that step (I) increases the existence ratio of hydroxyl groups on the particle surface, and the like, which makes the surface state of the particles more susceptible to change. This also is considered one of the reasons why a spherical boron nitride powder having a tapped density of 0.30 g/cm³ or more is more easily obtained.

### (Raw Material Powder)

The raw material powder is not particularly limited, and a spherical boron nitride powder prepared by any method can be used as a raw material powder. From the perspective of making it easier to obtain a spherical boron nitride powder having a tapped density of 0.30 g/cm³ or more, it is preferable to use a raw material powder prepared with the method described in Patent Document 2. That is, a precursor of a boron nitride powder is prepared by reacting boric acid ester and ammonia in an inert gas stream at 750 °C or more (preferably 750-1,300 °C, more preferably 800-1,200 °C) for 30 seconds or less so that the molar ratio of the ammonia/boric acid ester is 1-10. Thereafter, the precursor of the boron nitride powder is heat-treated at 1,000-1,600 °C for 1 hour or more (preferably 1-8 hours, more preferably 2-7 hours) in an atmosphere of ammonia gas or a mixed gas of ammonia gas and inert gas, thereby preparing a second precursor. In addition, it is preferable to calcine the second precursor at 1,800-2,200 °C under an atmosphere of an inert gas for 0.5 hours or more (preferably 2-8 hours, more preferably 3-7 hours), thereby obtaining a spherical boron nitride powder as a raw material.

Examples of the above-mentioned boric acid ester include, for example, trimethyl borate.

The raw material powder may have an average particle diameter (D50) of 0.01 μm or more, 0.05 μm or more, 0.1 μm or more, 0.2 μm or more, 0.3 μm or more, or 0.4 μm or more. Moreover, the upper limit may be 1.0 μm or less, 0.9 μm or less, 0.8 μm or less, or 0.7 μm or less. For the D50 of the raw material powder, any combination of the above-mentioned upper and lower limits may be adopted so long as the obtained spherical boron nitride powder has a tapped density in a range of 0.30 g/cm³ or more. In one embodiment, the raw material powder may have a D50 of 0.01-1.0 μm or 0.3-0.8 μm. Note that the average particle diameter (D50) of the raw material powder can be measured with the same method as for the spherical boron nitride powder.

The raw material powder may have an average circularity of preferably 0.70 or more, more preferably 0.75 or more, even more preferably 0.8 or more, and particularly preferably 0.87 or more. Note that the average circularity of the raw material powder can be measured with the same method as for the spherical boron nitride powder.

The raw material powder may have a specific surface area of 5-30 m²/g, 6-27 m²/g, 7-25 m²/g, 8-22 m²/g, or 10-20 m²/g. Note that the specific surface area of the raw material powder can be measured with the same method as for the spherical boron nitride powder.

### (Cavitation Bubbles)

Examples of methods of preparing a liquid containing cavitation bubbles include a method of depressurizing a liquid, a method of utilizing ultrasonic waves, a method of utilizing fluid dynamics, and the like. By using commercially available devices, it is possible to prepare a liquid containing cavitation bubbles with these methods. In one embodiment, the method of utilizing fluid dynamics may be employed. For example, using a commercially available powder suction continuous dissolution and dispersion device to prepare a liquid containing cavitation bubbles is preferable, and generating cavitation bubbles while circulating the liquid is particularly preferable.

Powder suction continuous dissolution and dispersion devices generally have a mechanism for generating flow velocity by using stirring blades. In one embodiment, stirring blades have a rotation speed of preferably 2,000-10,000 rpm, more preferably 4,000-9,000 rpm, even more preferably 4,500-8,000 rpm, still even more preferably 5,000-8,000 rpm, and particularly preferably 6,000-7,200 rpm.

In one embodiment, step (I) preferably includes generating cavitation bubbles in a liquid. That is, dispersing a raw material powder in the liquid while generating cavitation bubbles makes it easier to break down aggregated particles in the raw material powder.

In one embodiment, the process for generating cavitation bubbles is preferably performed 50 times or more, more preferably 100 times or more, and even more preferably 150 times or more, the number of times the cavitation process is performed being calculated from the rotation speed (rpm) of the stirring blades of the device and the discharge amount.

### (Liquid)

In the production method according to the present embodiment, the liquid used to disperse the raw material powder is not particularly limited as long as it has the effects of the present invention. From the perspective of ease of drying after processing and blendability with the spherical boron nitride powder, the liquid may be a liquid consisting only of an organic solvent such as ethanol or may be a mixed solution of water and an organic solvent.

In the case of a mixed solution of water and an inorganic solvent, the water in the mixed solution may have a content of preferably 80 mass % or more, more preferably 90 mass % or more, and even more preferably 95 mass % or more. In one embodiment, it is particularly preferred that the above-mentioned liquid is a liquid consisting only of water.

From the perspective of effectively generating cavitation in a liquid and suppressing liquid volatilization, the liquid temperature in step (I) is preferably 10-50 °C, and more preferably 20-30 °C.

The proportion of the raw material powder dispersed in the liquid is preferably 5-30 mass %, more preferably 5-20 mass %, and even more preferably 5-15 mass % with respect to the total amount of the liquid and raw material powder (100 mass %). In one embodiment, the proportion of the raw material powder may be 5-10 mass % or 8-10 mass %.

The time for performing step (I) is not particularly limited as long as it has the effects of the present invention. From the perspective of easily enhancing the efficiency of recovering the broken-down powder or of suppressing variability in the breaking down of the processed powder, the time of step (I) may be extended. In one embodiment, step (I) may be 5 minutes or more and 24 hours or less, 5 minutes or more and 20 hours or less, or 5 minutes or more and 10 hours or less.

### <Step (II)>

Step (II) is a step of, after step (I), recovering the raw material powder from the liquid and then drying the recovered raw material powder. Examples of methods of recovering the raw material powder from the liquid include filtration process (such as decompressing filtration and vacuum filtration), centrifugal separation, and the like.

Examples of methods of drying the recovered raw material powder include high-temperature air drying, decompression drying, and the like.

In one embodiment, the drying temperature of the raw material powder is preferably 80-150 °C, and more preferably 100-120 °C. Moreover, the drying time is preferably 2-24 hours and more preferably 5-12 hours.

The production method according to the present embodiment may include steps other than the above-mentioned steps (I) and (II) (other steps). Examples of the other steps include loosening the spherical boron nitride powder, and the like.

### [Resin Composition]

The resin composition according to the present embodiment contains: the above-mentioned spherical boron nitride powder; and at least one resin selected from the group consisting of a thermoplastic resin and a thermosetting resin.

The proportion of the spherical boron nitride powder in the resin composition is not particularly limited and may be adjusted, as appropriate, according to the objectives. For example, the proportion may be in the range of 1-99 mass % or in the range of 5-80 mass % with respect to the total mass of the resin composition. From the perspective of obtaining a resin composition having more excellent fluidity, the spherical boron nitride powder in the resin composition may have a content of preferably 5-30 volume %, more preferably 10-25 volume %, and even more preferably 15-20 volume %, with respect to the total mass of the resin composition. In one embodiment, the spherical boron nitride powder in the resin composition may have a content of 5 volume % or more and 20 volume % or less with respect to the total mass of the resin composition.

Moreover, from the perspective of obtaining a resin composition having a high thermal conductivity while maintaining fluidity, the spherical boron nitride powder in the resin composition may have a content of 50-80 volume %, 60-80 volume %, 70-80 volume % with respect to the total mass of the resin composition. In one embodiment, the spherical boron nitride powder in the resin composition may have a content of 70 volume % or more and 80 volume % or less with respect to the total mass of the resin composition.

### <Resin>

The resin composition according to the present embodiment contains at least one resin selected from a thermoplastic resin and a thermosetting resin. More specifically, examples include polyethylene resins; polypropylene resins; epoxy resins; silicone resins; phenolic resins; melamine resins; urea resins; unsaturated polyester resins; fluororesins; polyamide-based resins such as polyimide resins, polyamide-imide resins, and polyether imide resins; polyester-based resins such as polybutylene terephthalate resins and polyethylene terephthalate resins; polyphenylene sulfide resins; wholly aromatic polyester resins; polysulfone resins; liquid crystal polymer resins; polyethersulfone resins; polycarbonate resins; maleimide modified resins; ABS resins; acrylonitrile-acrylic rubber-styrene (AAS) resins; acrylonitrile-ethylene-propylene-diene rubber-styrene (AES) resins; hydrocarbon-based elastomer resins; polyphenylene ether resins; aromatic polyene-based resins; and the like. The foregoing may be used alone or as a combination of two or more.

The resin composition can have other additives blended therein to the extent that the other additives do not hinder the effects of the present invention. Examples of the other additives include rubber substances such as silicone rubbers, polysulfide rubbers, acrylic rubbers, butadiene-based rubbers, styrene-based block copolymers, and saturated elastomers; resinous substances such as silicone resins; resins in which epoxy resins or phenol resins are partially or wholly modified by amino silicone, epoxy silicone, alkoxy silicone, and the like; flame retardant promoters such as Sb₂O₃, Sb₂O₄, and Sb₂O₅; flame retardants such as halogenated epoxy resins and phosphorus compounds; colorants such as carbon black, iron oxide, dyes, and pigments; and the like. The foregoing may be used alone or as a combination of two or more.

### <Production Method of Resin Composition>

The production method for a resin composition is not particularly limited, and the resin composition may be produced, for example, by stirring, dissolving, mixing, or dispersing prescribed amounts of each material. The devices for mixing, stirring, dispersing, etc., these mixtures are not particularly limited, and it is possible to use a mortar machine, a three-roll mill, a ball mill, a planetary mixer, etc., provided with a stirring and heating device. The foregoing devices may also be used in combination, as appropriate.

### EXAMPLES

The present invention shall be explained still more specifically by referring to the examples below, but interpretation of the present invention is not limited by these examples.

### (Preparation of Raw Material Powder)

A raw material powder (spherical boron nitride powder 1, which is the raw material) was produced by the following procedure.
(1) A reaction tube (quartz tube) set in a resistance heating furnace was heated to increase the temperature to 1150 °C. Nitrogen gas was passed through trimethyl borate and then introduced to the reaction tube to introduce trimethyl borate into the reaction tube. Next, ammonia gas was introduced into the reaction tube directly. The molar ratio (ammonia/trimethyl borate) of the amount of ammonia introduced with respect to the amount of trimethyl borate introduced was set so as to be 1.8. The trimethyl borate and ammonia were reacted to obtain a boron nitride powder precursor (white powder).
(2) The obtained boron nitride powder precursor was put into a crucible set in a resistance heating furnace and made of boron nitride, and nitrogen gas and ammonia gas were separately introduced into the reaction tube at respective flow rates of 10 L/minute and 15 L/minute. The reaction tube was heated for 5 hours at 1500 °C to obtain a second precursor.
(3) The obtained second precursor was put into a crucible made of boron nitride and was heated for 5 hours at 2000 °C in an induction heating furnace in a nitrogen atmosphere to obtain a raw material powder (spherical boron nitride powder, which is the raw material).

### Examples 1-5 and Comparative Example 1

The raw material powder (10 mass %) was dispersed in ion-exchanged water, in which cavitation bubbles were generated, using a powder suction continuous dissolution and dispersion device (product name: JET PASTER®, model number: JPSS, manufactured by Nihon Spindle Manufacturing Co., Ltd.) (step (I)). Note that the cavitation bubbles in the ion-exchanged water were generated by setting the rotation speed of the stirring blades of the above-mentioned device to the values shown in Table 1. After performing step (I), filtration was performed to recover the raw material powder. Thereafter, the raw material powder was dried at the temperatures and times shown in Table 1 to obtain the spherical boron nitride powders of Examples 1-5. Note that in Comparative Example 1, the above-mentioned steps (I) and (II) were not performed.

With respect to the spherical boron nitride powders in the examples, the tapped density, average particle diameter (D50), average particle diameter (D90), average particle diameter (D10), specific surface area, average circularity, and O₁ₛ semi-quantitative value were measured under the following conditions. Moreover, the fluidity of the resin compositions containing the spherical boron nitride powders were evaluated under the following conditions. The results are shown in Table 1.

### (Measurement of Tapped Density)

First, a spherical boron nitride powder was dried at 120 °C for 5 hours. Thereafter, 5.00±0.02 g (M1) of the spherical boron nitride powder after drying was measured with a precision balance (a precision balance with a minimum weighing value of 0.001 g) and fed into a 50 mL graduated cylinder. Next, the graduated cylinder was lifted and dropped 500 times from a height of 3.5 cm. At this time, the graduated cylinder was dropped onto a rubber mat (with a thickness of 40 mm) so that the impact on the graduated cylinder is the same each time. After being dropped 500 times, the volume (V1) of the spherical boron nitride powder within the graduated cylinder was visually measured (to one decimal point). The tapped density of the spherical boron nitride powder was calculated from the following formula (1). The tapped density was calculated to two decimal points, rounding off the third decimal point. Moreover, the tapped density was calculated in “g/cm³”, with 1 mL in the graduated cylinder being 1 cm³. Note that the above-mentioned tapped density was measured under conditions of a temperature of 23 °C and a humidity of 50%.

Tapped density (g/cm³): spherical boron nitride powder mass (M1)/V1 (1)

### (Measurement of Average Particle Diameters (D10), (D50), and (D90))

After 0.01 g of the spherical boron nitride powder was dispersed in 80 mL of ethanol, a dispersing process was performed with a homogenizer, and the volume-based particle size distribution was measured with a laser diffraction/scattering-method particle size distribution measuring device (product name: LS-13 320 manufactured by Beckman-Coulter, Inc.). At this time, 1.359 was used as the refractive index of the ethanol.

In the obtained frequency distribution of particle sizes, the average particle diameters (D10), (D50), and (D90) (μm) were respectively determined from the particle diameter in which the cumulative value corresponds to 10%, the particle diameter in which the cumulative value corresponds to 50%, and the particle diameter in which the cumulative value corresponds to 90%.

### (Measurement of Specific Surface Area)

The BET specific surface area of the spherical boron nitride powder was measured with the BET multiple-point method using nitrogen gas, in accordance with JIS Z 8830:2013.

### (Measurement of O₁ₛ Semi-Quantitative Value)

A semi-quantitative value (that is, O₁ₛ peak area) was calculated from an O₁ₛ peak intensity by using an X-ray photoelectron spectroscopy device (product name: K-Alpha type X-ray photoelectron spectrometer manufactured by Thermo Fisher Scientific Inc., AI X-ray source with monochromator; measurement region: 400×200 μm) to measure a spectrum according to the manual, and then removing the background of the spectrum with the Shirley method.

The fluidity of the resin compositions containing the spherical boron nitride powders were evaluated under the following conditions.

### (Measurement of Viscosity of Resin Composition (Fluidity Evaluation))

An epoxy resin (product name: “YDF-8170C” manufactured by NIPPON STEEL Chemical & Material Co., Ltd.) had a dispersing agent (product name: “DISPERBYK-111” manufactured by BYK Chemie Japan, 0.3 mass %), an SC agent (product name: “3-Glycidyloxypropyltrimethoxysilane” manufactured by Tokyo Chemical Industry, Ltd., 1 mass %), and the spherical boron nitride powder according to the examples and comparative example (15 mass %) added thereto, and the obtained mixture was kneaded for 3 minutes at room temperature, a revolution speed of 2,000 rpm, and a rotation speed of 800 rpm using a hybrid mixer (product name: “Awatori Rentaro® AR-250” manufactured by Thinky Corporation). Thereafter, the mixture was kneaded twice using a three-roller miller (e.g., product name: “BR-150VIII” manufactured by Aimex Co., Ltd., gap: 10 μm, finishing roll rotation speed: 60 rpm) to obtain a resin composition for evaluation. The viscosity of the obtained resin composition was measured at the time of shear rate 0.1 (1/s) when the shear rate was varied, at 25 °C, from 0.01 (1/s) to 100 (1/s) and then back from 100 (1/s) to 0.01 (1/s) to measure the viscosity using a rheometer (product name: “MCR92” manufactured by Anto Paar GmbH”). Moreover, evaluation was performed in accordance with the evaluation criteria below, and a grade of C or better was considered passing.

### (Evaluation Criteria)

A: The viscosity at shear rate 0.1 (1/s) is 10 Pas or less.
B: The viscosity at shear rate 0.1 (1/s) is more than 10 Pas and 50 Pa·s or less.
C: The viscosity at shear rate 0.1 (1/s) is more than 50 Pas and 100 Pa's or less.
D: The viscosity at shear rate 0.1 (1/s) is 100 Pa·s or more.

TABLE 1

| | | | | EX. 1 | EX. 2 | EX. 3 | EX. 4 |
|---|---|---|---|---|---|---|---|
| PRODUCTION | DISPERSED SOLUTION | | | ION- | ION- | ION- | ION- |
| METHOD | | | | EXCHANGED | EXCHANGED | EXCHANGED | EXCHANGED |
| | | | | WATER | WATER | WATER | WATER |
| | STEP (I) | PRESENCE OR ABSENCE OF | | PRESENT | | | |
| | | CAVITATION BUBBLES | | | | | |
| | | DEVICE | (—) | POWDER SUCTION CONTINUOUS | | | |
| | | | | DISSOLUTION AND DISPERSION DEVICE | | | |
| | | ROTATION SPEED | (rpm) | 7,200 | 7,200 | 7,200 | 7,200 |
| | | PROCESSING TIME | (min) | 60 | 60 | 30 | 10 |
| | STEP (II) | DRYING | (°C) | 120 | 120 | 120 | 120 |
| | | TEMPERATURE | | | | | |
| | | DRYING TIME | (hr) | 5 | 12 | 12 | 12 |
| PROPERTIES | TAPPED DENSITY | | (g/cm³) | 0.59 | 0.53 | 0.63 | 0.59 |
| | AVERAGE PARTICLE DIAMETER | | (μm) | 0.54 | 0.57 | 0.54 | 0.55 |
| | (D50) | | | | | | |
| | AVERAGE PARTICLE DIAMETER | | (μm) | 0.33 | 0.33 | 0.34 | 0.34 |
| | (D10) | | | | | | |
| | AVERAGE PARTICLE DIAMETER | | (μm) | 1.71 | 0.70 | 1.71 | 1.74 |
| | (D90) | | | | | | |
| | SPECIFIC SURFACE AREA | | (m²/g) | 14 | 14 | 14 | 13 |
| | AVERAGE CIRCULARITY | | (—) | 0.87 | 0.87 | 0.87 | 0.87 |
| | O_{1S} SEMI-QUANTITATIVE VALUE | | (—) | 1.5 | 1.4 | 0.9 | 0.7 |
| EVALUATION | FLUIDITY | VISCOSITY OF RESIN | (Pa · s) | 2.8 | 3.4 | 7.3 | 24.9 |
| RESULT | | COMPOSITION | | | | | |
| | | (SHEAR RATE 0.1 | | | | | |
| | | [1/s]) | | | | | |
| | | EVALUATION | (—) | A | A | A | B |

| | | | | | COMP. |
|---|---|---|---|---|---|
| | | | | EX. 5 | EX. 1 |
| PRODUCTION | DISPERSED SOLUTION | | | ION- | NO |
| METHOD | | | | EXCHANGED | DISPERSION |
| | | | | WATER | PROCESSING |
| | STEP (I) | PRESENCE OR ABSENCE OF | | PRESENT | |
| | | CAVITATION BUBBLES | | | |
| | | DEVICE | (—) | POWDER SUCTION CONTINUOUS | |
| | | | | DISSOLUTION AND DISPERSION DEVICE | |
| | | ROTATION SPEED | (rpm) | 6,000 | |
| | | PROCESSING TIME | (min) | 60 | |
| | STEP (II) | DRYING | (°C) | 120 | |
| | | TEMPERATURE | | | |
| | | DRYING TIME | (hr) | 12 | |
| PROPERTIES | TAPPED DENSITY | | (g/cm³) | 0.56 | 0.28 |
| | AVERAGE PARTICLE DIAMETER | | (μm) | 0.54 | 0.62 |
| | (D50) | | | | |
| | AVERAGE PARTICLE DIAMETER | | (μm) | 0.34 | 0.34 |
| | (D10) | | | | |
| | AVERAGE PARTICLE DIAMETER | | (μm) | 1.72 | 1.92 |
| | (D90) | | | | |
| | SPECIFIC SURFACE AREA | | (m²/g) | 13 | 13 |
| | AVERAGE CIRCULARITY | | (—) | 0.87 | 0.87 |
| | O_{1S} SEMI-QUANTITATIVE VALUE | | (—) | 1.1 | 0.4 |
| EVALUATION | FLUIDITY | VISCOSITY OF RESIN | (Pa · s) | 8.5 | 208.4 |
| RESULT | | COMPOSITION | | | |
| | | (SHEAR RATE 0.1 | | | |
| | | [1/s]) | | | |
| | | EVALUATION | (—) | A | D |

As shown in Table 1, it was discovered that the spherical boron nitride powders of Examples 1-5 having a tapped density of 0.30 g/cm³ or more had a low viscosity and excellent fluidity in the resin compositions. Meanwhile, as shown in Comparative Example 1, a conventional spherical boron nitride powder has a tapped density of less than 0.30 g/cm³, and does not satisfy the configuration of the present invention. Such spherical boron nitride powders had higher viscosity and poorer fluidity in the resin composition compared to the spherical boron nitride powders in Examples 1-5. From the above results, it was confirmed that the spherical boron nitride powder according to the present embodiment can achieve excellent fluidity when blended in a resin.

### INDUSTRIAL APPLICABILITY

The spherical boron nitride powder according to the present embodiment can provide a resin composition having excellent fluidity. Therefore, the spherical boron nitride powder can be preferably used as a resin filler.

1. A spherical boron nitride powder having a tapped density of 0.30 g/cm³ or more.

2. The spherical boron nitride powder according to claim 1, wherein the spherical boron nitride powder has an average particle diameter (D50) of 2.0 μm or less.

3. The spherical boron nitride powder according to claim 1, wherein the spherical boron nitride powder has an average particle diameter (D90) of 10.0 μm or less and an average particle diameter (D10) of 0.5 μm or less.

4. The spherical boron nitride powder according to claim 1, wherein the spherical boron nitride powder has an average circularity of 0.70 or more.

5. The spherical boron nitride powder according to claim 1, wherein the spherical boron nitride powder has a specific surface area of 5 m²/g or more.

6. The spherical boron nitride powder according to claim 1, wherein a semi-quantitative value calculated from an O₁ₛ peak intensity measured by X-ray photoelectron spectroscopy is 0.6 or more.

7. The spherical boron nitride powder according to claim 1, wherein the spherical boron nitride powder is for filling a resin.

8. A resin filler comprising the spherical boron nitride powder according to claim 1.

9. A resin composition comprising: the spherical boron nitride powder according to claim 1; and at least one resin selected from the group consisting of a thermoplastic resin and a thermosetting resin.
